(19) United States
(12) Patent Application Publication
(10) Pub. No.: US 2001/0002277 A1
(43) Pub. Date: May 31, 2001

(54) PHOSPHOR ENCAPSULATION METHOD USING SERIGRAPHY DEPOSITION

(76) Inventor: REMI VALERO, MONTPELLIER (FR)

Correspondence Address: ARTHUR L. PLEVY, BUCHANAN INGERSOLL, P. C., 650 COLLEGE ROAD EAST, 4TH FLOOR, PRINCETON, NJ, 08540, US

(21) Appl. No.: 09/432,735

(22) Filed: Nov. 2, 1999

(30) Foreign Application Priority Data
Nov. 9, 1998 (FR) 98-14226

(51) Int. Cl. B05D 7/00; B05D 3/02

(52) U.S. Cl. 427/215; 427/376.2; 427/71

(57) ABSTRACT

A method of forming a zinc or indium oxide layer at the surface of phosphors deposited by serigraphy on a substrate, including the steps of adding the grains to a solution of a serigraphy binder in water, dissolving in the solution a zinc or indium nitrate, performing the serigraphy deposition, and annealing.

### BACKGROUND OF THE INVENTION

1. Field of the Invention

The present invention relates to the deposition of phosphors on a substrate, for example, an anode conductive track of a flat display screen.

2. Discussion of the Related Art

In some display systems, such as flat microtip display screens, conductive layers or tracks that are coated with phosphors, that is, with grains of a material that emits light when submitted to an electron bombarding, are provided on the anode side.

To improve the phosphor properties, and the general display properties, especially to avoid outgassing phenomena, it is desirable to cover the phosphor layers with a protective layer. This protective layer mist be transparent for electrons and photons to enable the basic phosphor operation. It must be a barrier against ions to avoid outgassing of the phosphors.

Rather than depositing a uniform layer at the surface of the phosphor layer, it may be desired to coat each phosphor. This has the additional advantages of improving the electric connection between the phosphors and the anode conductive layer and avoiding phosphor agglomeration problems upon annealing.

Known phosphor coating methods are complex methods. A Sol Gel method is for example used, with as a synthesis precursor an alcoxide such as an isopropoxide. The major disadvantage of this method is that large aggregates, with a diameter of more than 10 μm, are obtained, which is incompatible with current methods of flat screen manufacturing, in particular with the serigraphy method.

### SUMMARY OF THE INVENTION

The present invention aims at providing a novel method of phosphor coating implemented in the context of a phosphor serigraphy method, practically without modifying this serigraphy method.

The present invention more specifically relates to the case where the phosphor coating layer is a zinc oxide layer (ZnO) or an indium oxide layer (In₂O₃).

It should be reminded that, in a conventional method of serigraphy of grains of a phosphor material on an anode conductive surface, the main following steps are performed:

preparing a solution, substantially with 10% of polyvinyl alcohol (PVA) in water;

adding the phosphors to the solution;

performing the actual serigraphy, that is, applying with a scraper the obtained paste through a thin grid;

annealing.

8 g of phosphor in 10 g of solution will for example be used. Preferably, an antifoaming agent such as that sold by Clariant laboratories under the name WLN is also added. The anneal is for example performed at 450° C. for 15 hours and results in eliminating the PVA and only leaving in place the phosphors, for example, Gd₂O₂S:Tb (green), Y₂SiO₅:Tb (green), ZnO:Zn (green), Y₂SiO₅:Ce (blue), Y₂O₃:Eu (red). As mentioned previously, a disadvantage of this method is that the conditions must be critically chosen so that the grains slightly adhere together without however completely agglomerating.

As compared to this known method, the present invention only provides the modification of adding indium nitrate or zinc nitrate to the PVA solution under magnetic agitation. The conventional serigraphy method is then carried out and, at the end of the anneal, a deposition of a layer of ZnO or In₂O₃ of a thickness on the order of a few nm is observed at the surface of the phosphors, which for example have a diameter on the order of a few μm.

The thickness of the ZnO or In₂O₃ layer especially depends on the indium or zinc nitrate in the PVA solution. For example, to obtain thicknesses varying between 10 nm and 30 nm, a solution of 0.1 g to 0.6 g of indium nitrate or zinc nitrate in 10 g of solution at 10 or 12% or PVA may be used.

According to an embodiment of the present invention, the phosphor is added in a proportion of 6 g to 10 g for 10 g of solution.

According to an embodiment of the present invention, the anneal is pursued at a temperature on the order of 400° C. to 500° C. for several hours.

The present invention is likely to have various alterations, modifications, and improvements which will readily occur to those skilled in the art. Instead of PVA, another binder useable in serigraphy may be used, for example, polyvinyl pyrrolidone (PVP). The anneal durations may be chosen according to the desired structure of the encapsulating material; for example, for an anneal from two to ten hours, an amorphous encapsulator will be obtained, while for an anneal of ten to twenty hours, a partially or totally crystallized encapsulator will be obtained.

The foregoing description is by way of example only and is not intended to be limiting. The present invention is limited only as defined in the following claims and the equivalents thereto.

What is claimed is:

1. A method of forming a zinc or indium oxide layer at the surface of phosphors deposited by serigraphy on a substrate, the serigraphy deposition including the steps of:
adding the grains to a water solution of a serigraphy binder wherein a zinc or indium nitrate has been previously dissolved,
performing the serigraphy deposition,
annealing.

2. The method of claim 1, wherein the nitrate is dissolved in a proportion of 0.1 g to 0.6 g for 10 g of solution.

3. The method of claim 1, wherein the phosphor is chosen from the group including Gd₂O₂S:Tb, Y₂SiO₅:Tb, Y₂SiO₅:Ce, Y₂O₃:Eu, ZnO:Zn.

4. The method of claim 3, wherein the phosphor is added in a proportion of 6 g to 10 g for 10 g of solution.

5. The method of claim 1, wherein an antifoaming agent is added to the solution.

6. The method of claim 1, wherein the anneal is pursued at a temperature on the order of 400° C. to 500° C. for several hours.

7. The method of claim 1, wherein the serigraphy binder is PVA.
